(19) United States
(12) Patent Application Publication
(10) Pub. No.: US 2016/0172672 A1
(43) Pub. Date: Jun. 16, 2016

(54) METHOD OF POSITIVE ELECTRODE MATERIAL PREPARATION AND APPLICATION

(71) Applicant: Shanghai Zhaowei Technology Development Co., Ltd., Pleasanton, CA (US)

(72) Inventors: Shi Yuan, San Ramon, CA (US); Yu Yuan, Santa Clara, CA (US)

(21) Appl. No.: 14/969,488

(22) Filed: Dec. 15, 2015

(30) Foreign Application Priority Data
Dec. 15, 2014 (CN) 201410776175.1

(51) Int. Cl. H01M 4/485; C01G 53/00; H01M 10/052

(52) U.S. Cl. CPC H01M 4/485; H01M 10/052; C01G 53/006; H01M 2004/028

(57) ABSTRACT

The cathode of a lithium ion battery is prepared from a material containing tungsten. In another preferred embodiment, the cathode material is based cathode material containing high manganese and tungsten. In another preferred embodiment, the cathode material is Li_{1+δ}NiₐCo_{b}Mn_{c}WₑO₂.

### CROSS-REFERENCE TO RELATED APPLICATIONS

The present application claims the benefit of priority to the Chinese Patent Application of the same title having application number: 201410776175.1, filed on Dec. 15, 2014, which is incorporated herein by reference.

### BACKGROUND

The field of Invention is lithium battery materials, particularly to a lithium battery positive electrode material preparation method and application.

Global energy crisis and the increasingly serious air pollution, makes it necessary to develop new clean energy-based transportation. Lithium-ion batteries offer clean energy alternative, with good safety, long cycle life, non-toxic and no pollution.

Lithium-ion batteries typically include an anode, a cathode, a separator and electrolyte. Modern lithium-ion batteries typically have a carbon anode and a transition metal oxide cathode. The cathode and anode typically are layered structure to hold lithium ions. During charging and discharging, the lithium ion transport between the cathode and the anode.

Cathode material in lithium-ion battery is a key factor in determining battery safety, capacity and price. In the current commercial production of lithium-ion batteries, cathode materials cost approximately 20˜40% of the total cost of the battery, reducing the price of cathode material directly determines the reduced price of lithium-ion batteries, lithium-ion battery is especially true. In addition, power-type battery in high-current discharge than the special requirements of the energy, security and other aspects of price, more highlights the importance of a positive electrode material. The current study and are trying to use a lithium-ion battery cathode materials are not yet fully meet the requirements, which greatly restricted the development of lithium-ion battery.

The first generation of lithium ion battery cathode is LiCoO₂ cathode, which is a layered compound. In LiCoO₂ structure, oxygen atoms form a close-packed structure, and form the same number of octahedral voids. Layers of lithium and cobalt alternately fill these octahedral voids. When half of the lithium (voltage higher than 4.2V) is removed, this layered compound becomes unstable. Also, as cobalt metal is expensive, the price of lithium cobalt oxide is high.

In order to improve their performance and reduce costs, Ni and Mn atoms are used to replace cobalt, the resultant product remains layered structure. These compounds are generally known as ternary materials (NCM) (U.S. Pat. No. 6,964,828, which is incorporated herein by reference).

The initial ternary material is LiNi_{0.333} Co_{0.333} Mn_{0.333} O₂. In order to increase the capacity, the structure and composition of ternary materials is improved in two directions. One is to increase the nickel content, such as LiNi_{0.5}Co_{0.2} Mn_{0.3}, the other one is to increase the relative amounts of lithium and manganese, such as high manganese lithium-rich material proposed by Argonne National Laboratory (Argonne National Lab) [U.S. Pat. No. 6,680,143, which is incorporated herein by reference]. Due to the excess of lithium, this material has been considered a mixture of the two structures at nanoscale. This material has a “a general formula x LiM′O2−(1−x) Li₂MnO₃, in which 0<x<1, and where M is one or more ion with an average trivalent oxidation state and with at least one ion being Mn or Ni, and where M′ is one or more ion with an average tetravalent oxidation state.”

The performance of high manganese is strongly affected by the content of Li₂MnO₃. High Li₂MnO₃ content leads to high reversible capacity and high irreversible capacity loss. There has been high expectation for high manganese materials, but its commercialization has still not occurred. Therefore, there is an urgent need to provide an inexpensive and effective high manganese lithium-rich material.

Accordingly, it is an object of present invention to provide improved high capacity batteries, with that have a light weight, long life and great stability.

It is another object to at least partially obtain such improvements in Lithium ion batteries that contain among other transition metals, manganese in the cathode materials for high capacity.

### SUMMARY OF THE INVENTION

In the present invention, the first object is achieved by providing a lithium battery cathode material, characterized in that the cathode material comprises an oxide of lithium and tungsten.

A second aspect of the invention is the lithium battery cathode material, characterized in that said cathode material further comprises on ore more of nickel, manganese and cobalt and tungsten.

Another aspect of the invention is the lithium battery cathode material, characterized in that the cathode material is Li_{1+δ}NiₐCo_{b}Mn_{c}WₑO2, wherein δ in the range of 0 to 0.2; a in the range of 0.05 to 0.5; b in the range from 0.05 to 0.4; c in the range 0.0.05 to 0.7; and e in the range of 0.001 to 0.15.

Another aspect of the invention is any of the above lithium battery cathode material wherein the lithium cell formed at 25° C., 2.0-4.6V, under 1/10 C of charge and discharge test, the discharge capacity is at least about 205 mAh.

Another aspect of the invention process for making a positive electrode material comprising the steps of mixing a soluble tungsten salt with a precipitating agent to obtain a first mixed solution, dissolving at least one soluble first transition metal salt (Me) to obtain a second mixed solutions, combining the first and second mixed solutions to precipitate an insoluble mixture of the first transition metal and a tungsten compound, rinsing the insoluble mixture of step c to remove soluble salts, providing a lithium compound, combining the lithium compound with the rinsed insoluble mixture of step d) to form a second mixture, calcining the second mixture to obtain a obtain a positive electrode material having the formula Li1_{+δ}MeₓWₑO2 wherein δ in the range of 0 to 0.2; x is in the range of 0.15 to 0.7; and e in the range of 0.001 to 0.15.

Another aspect of the invention is the above process for making a positive electrode material wherein the first transition metal salt (Me) comprises one or more metal selected from the group consisting of nickel, cobalt and manganese.

Another aspect of the invention is any of the above process for making a positive electrode material wherein said step of combining comprises adding each of the first and second mixed solutions to a container of water as a separate stream will the container is well mixed.

Another aspect of the invention is any of the above process for making a positive electrode material wherein the mixing soluble tungsten salt is Na₂WO₃.2H₂O.

Another aspect of the invention is any of the above process for making a positive electrode material wherein Na₂WO₃.2H₂O was added to NaCO₃ as the precipitating agent.

Another aspect of the invention is any of the above process for making a positive electrode material characterized in that the at least one soluble first transition metal salt is at least one selected from the group consisting of a sulfate, nitrate, acetate.

Another aspect of the invention is any of the above process for making a positive electrode material wherein the lithium compound is one of lithium carbonate and lithium hydroxide.

Another aspect of the invention is a lithium battery cathode material, characterized in that the cathode material comprises an oxide of lithium and tungsten having the formula Li_{1+δ}MeₓWeO₂ wherein Me is one or more metals δ in the range of 0 to 0.2; x is in the range of 0.15 to 0.7; and e in the range of 0.001 to 0.15.

Another aspect of the invention is such a lithium battery cathode material, wherein Me comprises one or more transition metals.

Another aspect of the invention is any of the above lithium battery cathode material, wherein e is in the range of 0.005 to 0.002.

The above and other objects, effects, features, and advantages of the present invention will become more apparent from the following description of the embodiments thereof taken in conjunction with the accompanying drawings.

### BRIEF DESCRIPTION OF THE DRAWING FIGURES

FIG. 1 shows the charge-discharge curves of Example I and Example II. Example II has tungsten dopant.

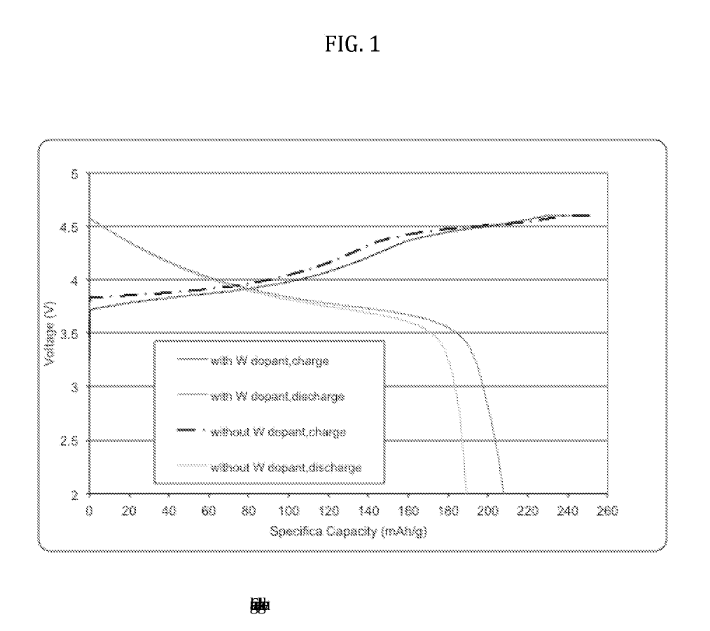

FIG. 2 shows the cycle data of cathode material prepared in Example II. The cathode material is tested in coin-type half cell prepared according to the steps described in previous section. As-prepared lithium coin-type half cell is tested at 25° C., within 2.0-4.6V voltage range, under 1/10 C charging and discharging current. Cycle curve reflects the capacity variation of cathode materials with the number of cycles.

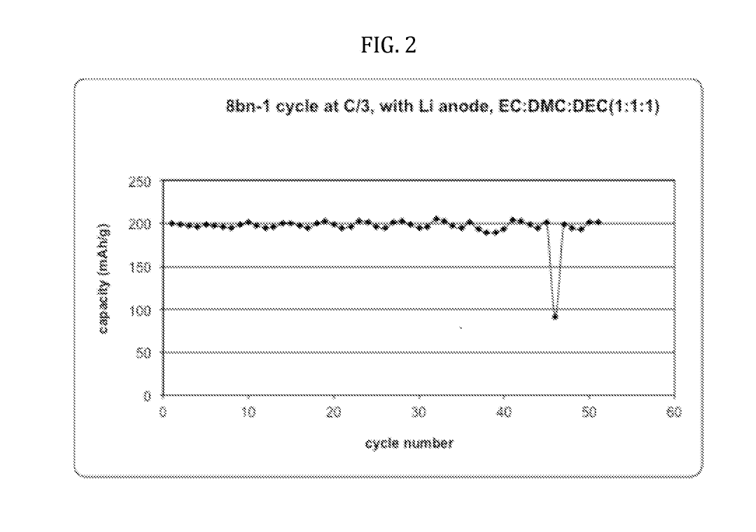

FIG. 3 shows X-ray diffraction pattern of Example II; The sample was placed on a quartz plate. The X-ray diffractometer is Rigaku Ultima III using the Cu Kα at a voltage of 40 kV.

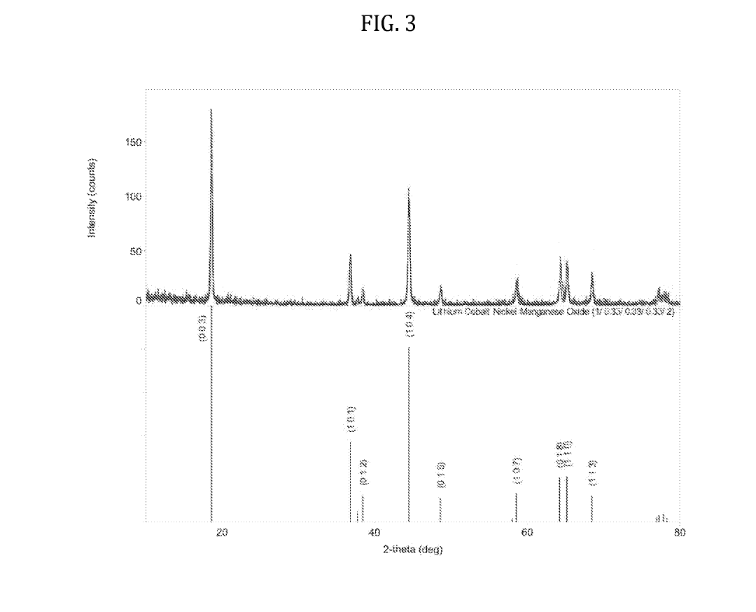

### DETAILED DESCRIPTION

High manganese lithium-rich materials are generally considered to be a mixture of LiMO2 and Li2MnO3 at nanoscale level. LiMO2 and lithium cobalt oxide having a similar structure, M is typically cobalt-nickel-manganese and other transition metal elements.

This inventor, after extensive and in-depth research, accidentally discovered tungsten doping wherein, with the same Li2MnO3 content, the capacity can be increased 15 mAh/g.

The main advantage of the present invention is that:

1, the present invention for the first time disclosing high manganese tungsten-containing cathode material;

2, high manganese cathode material of the present invention provides a high energy density;

3, the present invention discloses a high-manganese cathode materials with low production costs.

With reference to specific embodiments, the following section is to further illustrate the present invention. It should be understood that these examples are merely illustrative of the present invention and are not intended to limit the scope of the invention.

### Preparation Method

The second aspect of the present invention is to provide a method to prepare cathode material as described above. The process involves the steps of first preparing solutions of metal salts, which on mixing cause a co-precipitation of a water insoluble salt containing W and the other metals, that is preferably Ni, Mn and/or Co. The precipitated mixture is preferably a carbonate or hydroxide, which upon calcining to decomposition of the carbonate along with a Lithium Carbonate or Lithium Hydroxide, will formed a mixed Lithium Metal Oxide, in which the metal includes tungsten and one or more of Ni, MN and/or Co.

It is preferable in the process to deploy three containers. The first is the solution of Ni/Mn/Co or a mixture of one or more metal or transition metal sulfates in an aqueous solution. The second will be sodium carbonate solution with a soluble tungsten salt, the third container will be a reactor with small amount of DI water and is vigorously stirred. The solution from the 1st container and the solution from the second container will be added into the third container (reactor) in a predetermined ratio, and then a mixed Ni/Mn/Co/W carbonate will be precipitated.

The precipitated product is rinsed with water and dried. Then it is mixed with Lithium carbonate or Lithium hydroxide. The mixture is calcined to drive off CO2 and final product is obtained.

Hence, the process comprises a step of mixing a soluble tungsten salt with a precipitating agent to obtain a first mixed solution. In addition, one or more soluble metal salts, preferably transition metal salt, is mixed to obtain a second mixed solution. The counter ions in the first and second solutions are selected to form water insoluble precipitates of the metals in a compounds, such as a carbonate or hydroxide that can be them rinsed and calcined to form a mixed metal oxide.

Next, the second mixed solution and the first mixed precipitating solution are added to water together to achieve the co-precipitation reaction, and the precipitated product is called precursor. Then, a lithium compound and the precursor obtained in the precipitation step are mixed and calcined. This will generate the cathode material as described above in the present invention.

In another preferred embodiment, the transition metal comprises nickel, cobalt and manganese, but may also comprises other metals or transition metals.

In another preferred embodiment, the soluble salts of the second mixed solution are the sulfate, nitrate, acetate; lithium compound mixed with the precurser is optionally one or more of lithium carbonate and lithium hydroxide.

In another preferred embodiment, the precipitating agent in the first mixed solution include one or more of sodium carbonate, sodium hydroxide.

In the above-described precipitation step, flow rate of 3-7 ml/min is used to add the mixed solution and precipitant into water (preferably deionized water), via co-precipitation, to produce a precursor; wherein the precipitating agent comprises sodium carbonate, potassium sodium oxide. The molar ratio between precipitation agent and mixed metal solution is about 1:1. In the third step, the lithium compound and precursor is mixed at a molar ratio of 1:1 to 1.15:1, and heated in a calciner oven to 500-650° C., incubated 6-20 hours, then warmed to 750-1000° C., holding 9-24 hours, subsequently cooled to room temperature to obtain cathode material disclosed in this document.

The present invention shows that, with the same preparation method, tungsten doping can improve cathode materials capacity.

### Application

The above-described positive electrode material disclosed in the present invention may be use for the preparation of a lithium battery. Lithium battery, in addition to the cathode material prepared in the present invention, also contains other conventional materials, such as the negative electrode material, a separator, an electrolyte and the like.

Features of the present invention mentioned above, or embodiments mentioned characteristics can be arbitrarily combined. All of the features disclosed in the specification may be used in combination with any other properties, and the features disclosed in specification may be substituted by the same or similar alternative features. Therefore, unless otherwise stated, the disclosed feature could mean equal or similar features in general examples.

In the following examples where experimental methods do not indicate the specific conditions, general conventional conditions or conditions in accordance with the manufacturer recommended, are following. Unless otherwise indicated all percentages, ratios, proportions, or parts by weight.

Volume percentage by weight of the present invention to those skilled in the unit is known, for example, refers to the weight of the solution in 100 ml of solute.

Unless otherwise defined, all terms used here are similar to professional and scientific terminology familiar to those skilled in the field. In addition, any methods and materials similar or equal to the reported method can be applied to the methods of the invention. The method and the material in the preferred embodiment described herein is for demonstration purposes only.

### Cathode Material Prepared by Example Measured by Coin Cell

The Electrochemical properties of cathode materials is measured by coin-type half-cell. Half-cell positive electrode is composed of cathode material (above sample):(conductive agent) Super P:(binder) PVDF, made at a ratio of 80:10:10. The preparation of coin cells follows the teaching in U.S. Pat. No. 8,389,160 with minor modifications.

Cathode material (above sample) and Super P from MTI is mixed to form a uniform powder mixture. Polyvinylidene fluoride PVDF (MTI Corporation) is mixed with NMP (N-methylpyrrolidone)(MTI Corporation), and stirred overnight to form a PVDF-NMP solution. The powder mixture is then added to the PVDF-NMP solution and mixed for 4 hours to form slurry. The slurry is coated onto an aluminum foil current collector with a blade coater to form a thin wet film. The coated electrode was dried for 6 hours at 120° C. under vacuum to remove the NMP

The prepared cathode is then transferred to an argon-filled glove box and assembled into 2032 coin cell with anode, electrolyte solution and separator. Lithium-chip (MTI Corporation) is used as the negative electrode. 1M LiPF6 dissolved in a solution of ethylene carbonate, diethyl carbonate, dimethyl carbonate at 1:1:1 volume ratio is used as electrolyte. 25 um Trilayer polypropylene-polyethylene-polypropylene film (Celgard, Inc.) is used as separator.

Charge-discharge curve cases involved the implementation of the following measured by the following methods:

Cathode material prepared by the preparation method for preparing a lithium coin cell battery and a half. At 25° C., the inside 2.0-4.6V voltage range, under the conditions of 1/10 C for a single coin battery charge and discharge tests. Reflecting the positive electrode material charge-discharge curve of voltage change in the charge and discharge processes.

### Example 1

### Preparation of a Sample Embodiment

The NiSO4.6H2O, CoSO4.7H2O, and MnSO4.H2O of certain ratio is dissolved in deionized water to form a solution of 2.0M transition metals. Sodium carbonate is dissolved in deionized water to form 2.0M. In 500 ml beaker, 50 ml of deionized water is added. The water is maintained at 55° C. and stirred using a magnetic stirrer. The mixed transition metal solution and sodium carbonate are added into the beaker at 5 ml/min. The precipitation product is washed, filtrated and dried. This product is mixed with lithium carbonate and calcined at 600° C. temperature for 15 hours and then to 920° C. for 24 hours. The final materials is black powder. This cathode material is assembled into R2032 type coin cell battery as stated above and tested at 25° C., 2.0-4.6V, 1/10 C discharge test conditions, the discharge capacity of 190 mAh/g is obtained.

### Preparation Example 2

Samples embodiment #2 was prepared using a method similar to Example 1, except that the tungsten-containing compound to 1 mol percentage Na2WO3.2H2O was added to a 250 ml 2 M NaCO3 which acts as a precipitating agent with respect to one or more transition metal compounds in solution. NiSO4.6H2O, CoSO4.7H2O, and MnSO4.H2O with the same percentage as in Example 1 was dissolved in to deionized water to obtain a mixed solution at a concentration of 2.0 mol/L; The discharge capacity of obtained cathode material is 205 mAh/g.

It has been discovered that only a small amount of tungsten is necessary to improve battery capacity, as shown in Table I below in which all samples were prepared and tested as above.

TABLE I

| W dopant, % by wt. | Capacity of the battery, in mAh/g |
|---|---|
| 0 | 190 |
| 0.5 | 197 |
| 1.0 | 205 |
| 2 | 206 |

While the above table shows only a slight benefit of an increase from 1% W to 2% W, it is believed that the W content may be increased to at least 15% by weight and receive at least some of the above benefits. It is also believed that the W content can be as low as 0.1% and some of the above benefits may be obtained. Hence, it is generally preferred that the amount of W in the LiMO2 battery be from about 0.1 to 15 wt %, and more preferably, 0.1 to 2 wt %, and most preferably between about 0.5 to 2 wt. %.

### Comparison

Using the same manner as in Example, the compound containing niobium or lanthanum is added into is Na2CO3 precipitating agent, but found no positive effect.

### Cathode Materials

The present invention discloses as a preferred embodiment a lithium battery cathode material. It is a tungsten-containing manganese-based cathode material for lithium battery. It has a formula of Li_{1+δ}NiₐCo_{b}Mn_{c}WₑO2, wherein

δ in the range of 0 to 0.2;
a in the range of 0.05 to 0.5;
b in the range from 0.05 to 0.4;
c in the range 0.0.05 to 0.7;
e in the range of 0.001 to 0.15.

The foregoing is only preferred embodiments of the present invention only, not intended to limit the scope of the technical content of the substance of the present invention. The real teaching of the present invention is broadly defined in claims. For any technical methods, if the application is identical to the scope of the claims, or an equivalent, will be regarded as being covered by the scope of the right to claim.

We claim:

1) A lithium battery cathode material, characterized in that the cathode material comprises an oxide of lithium and tungsten.

2) A positive electrode material according to claim 1, characterized in that said cathode material further comprises on ore more of nickel, manganese and cobalt and tungsten.

3) The positive electrode material according to claim 1, characterized in that the cathode material is Li_{1+δ}NiₐCo_{b}Mn_{c}WₑO₂, wherein
a) δ in the range of 0 to 0.2;
b) a in the range of 0.05 to 0.5;
c) b in the range from 0.05 to 0.4;
d) c in the range 0.0.05 to 0.7;
e) e in the range of 0.001 to 0.15.

4) The positive electrode material according to claim 3, wherein the lithium cell formed at 25° C., 2.0-4.6V, under 1/10 C of charge and discharge test, the discharge capacity is at least about 205 mAh.

5) A process for making a positive electrode material comprising the steps of:
a) mixing a soluble tungsten (W) salt with a precipitating agent to obtain a first mixed solution,
b) dissolving at least one soluble first metal (Me) salt to obtain a second mixed solutions,
c) combining the first and second mixed solutions to precipitate an insoluble mixture of the first transition metal and a tungsten compound,
d) rinsing the insoluble mixture of step c to remove soluble salts,
e) providing a lithium (Li) compound,
f) combining the lithium compound with the rinsed insoluble mixture of step d) to form a second mixture,
g) calcining the second mixture to obtain a obtain a positive electrode material having the formula Li_{1+δ}MeₓWₑO₂ wherein:
i) δ in the range of 0 to 0.2;
ii) x is in the range of 0.15 to 0.7; and
iii) e in the range of 0.001 to 0.15.

6) The process for making a positive electrode material according to claim 5 wherein the first metal (Me) salt comprises one or more transition metals selected from the group consisting of nickel, cobalt and manganese.

7) The process for making a positive electrode material according to claim 5 wherein said step of combining comprises adding each of the first and second mixed solutions to a container of water as a separate stream while the container is well mixed.

8) The process for making a positive electrode material according to claim 5 wherein the mixing soluble tungsten salt in step a) is Na2WO3.2H2O.

9) The process for making a positive electrode material according to claim 8 wherein Na2WO3.2H2O was added to NaCO3 as the precipitating agent in step a).

10) The process for making a positive electrode material according to claim 5 characterized in that the at least one soluble first transition metal salt in step b) is at least one selected from the group consisting of a sulfate, nitrate, acetate.

11) The process for making a positive electrode material according to claim 5, wherein the lithium compound of step (e) is one of lithium carbonate and lithium hydroxide.

12) The process for making a positive electrode material according to claim 5 characterized in that the precipitating agent in step (a) comprises at least one of sodium carbonate and sodium hydroxide.

13) The process for making a positive electrode material according to claim 9 wherein the first transition metal salt (Me) comprises one or more metal selected from the group consisting of nickel, cobalt and manganese.

14) The process for making a positive electrode material according to claim 9 wherein said step of combining comprises adding each of the first and second mixed solutions to a container of water as a separate stream while the container is well mixed.

15) The process for making a positive electrode material according to claim 9 characterized in that the at least one soluble first transition metal salt in step b) is at least one selected from the group consisting of a sulfate, nitrate, acetate.

16) The process for making a positive electrode material according to claim 9, wherein the lithium compound of step (e) is one of lithium carbonate and lithium hydroxide.

17) The process for making a positive electrode material according to claim 9 characterized in that the precipitating agent in step (a) comprises at least one of sodium carbonate and sodium hydroxide.

18) A lithium battery cathode material, characterized in that the cathode material comprises an oxide of lithium and tungsten having the formula Li_{1+δ}MeₓWₑO₂ wherein Me is one or more metals:
i) δ in the range of 0 to 0.2;
ii) x is in the range of 0.15 to 0.7; and
iii) e in the range of 0.001 to 0.15.

19) The lithium battery cathode material of claim 18 wherein Me comprises one or more transition metals.

20) The lithium battery cathode material of claim 18 wherein e is in the range of 0.005 to 0.02.
